(19) United States
(12) Patent Application Publication
(10) Pub. No.: US 2022/0221282 A1
(43) Pub. Date: Jul. 14, 2022

(54) INFORMATION PROCESSING DEVICE, INFORMATION PROCESSING METHOD, AND PROGRAM

(71) Applicant: TOYOTA JIDOSHA KABUSHIKI KAISHA, Toyota-shi (JP)

(72) Inventor: Atsushi SAJIKI, Okazaki-shi (JP)

(73) Assignee: TOYOTA JIDOSHA KABUSHIKI KAISHA, Toyota-shi (JP)

(21) Appl. No.: 17/451,178

(22) Filed: Oct. 18, 2021

(30) Foreign Application Priority Data
Jan. 8, 2021 (JP) 2021-002174

(51) Int. Cl. G01C 21/34; G01C 21/36

(52) U.S. Cl. CPC G01C 21/343; G01C 21/3605; G01C 21/3438

(57) ABSTRACT

In an information processing device, a control unit detects a predetermined action taken by an employee to return home from a predetermined facility. Then, the control unit allocates, to the predetermined facility, a vehicle in which the employee rides, when the predetermined action is detected.

### CROSS-REFERENCE TO RELATED APPLICATION

This application claims priority to Japanese Patent Application No. 2021-002174 filed on Jan. 8, 2021, incorporated herein by reference in its entirety.

### BACKGROUND

### 1. Technical Field

The present disclosure relates to a technique for allocating a vehicle to be used by employees.

### 2. Description of Related Art

Japanese Unexamined Patent Application Publication No. 2003-216727 (JP 2003-216727 A) discloses a technique relating to a system for allocating a taxi to a medical institution. The system described in JP 2003-216727 A acquires in-hospital processing completion time of each patient who wishes to use a shared taxi. In addition, a plurality of patients who wishes to use a shared taxi, the patients living in the same residential area, is set as a group of patients who uses the same shared taxi. Then, the taxi company is instructed to allocate the taxi to the group of patients at vehicle allocation time determined based on the in-hospital processing completion time.

### SUMMARY

The purpose of the present disclosure is to improve convenience for employees when the employees return home from a predetermined facility.

An information processing device according to a first aspect of the present disclosure includes a control unit that executes: detecting a predetermined action taken by an employee to return home from a predetermined facility; and allocating, to the predetermined facility, a vehicle in which the employee rides, when the predetermined action is detected.

An information processing method according to a second aspect of the present disclosure is an information processing method executed by a computer, and includes: detecting a predetermined action taken by an employee to return home from a predetermined facility; and allocating, to the predetermined facility, a vehicle in which the employee rides, when the predetermined action is detected.

A program according to a third aspect of the present disclosure is a program that causes a computer to execute an information processing method. The information processing method includes: detecting a predetermined action taken by an employee to return home from a predetermined facility; and allocating, to the predetermined facility, a vehicle in which the employee rides, when the predetermined action is detected.

According to the present disclosure, it is possible to improve convenience for the employee when the employee returns home from the predetermined facility.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a schematic configuration of a vehicle allocation system;

FIG. 2 is a first block diagram schematically showing an example of a functional configuration of a management server;

FIG. 3 is a first diagram showing an example of a table configuration of user information;

FIG. 4 is a first flowchart showing information processing performed on the management server;

FIG. 5 is a second flowchart showing information processing performed on the management server;

FIG. 6 is a second diagram showing an example of a table configuration of user information;

FIG. 7 is a third flowchart showing information processing performed on the management server; and

FIG. 8 is a second block diagram schematically showing an example of the functional configuration of the management server.

### DETAILED DESCRIPTION OF EMBODIMENTS

An information processing device according to an embodiment of the present disclosure includes a control unit. The control unit detects a predetermined action taken by an employee at a predetermined facility. Here, the predetermined facility is a facility where the employee works. In addition, the predetermined action is an action taken by the employee to return home. That is, the predetermined action is an action taken by the employee at the predetermined facility before the employee leaves the predetermined facility to return home.

Then, when the predetermined action is detected, the control unit allocates a vehicle to the predetermined facility. The vehicle to be allocated is a vehicle in which the employee rides. That is, the employee can return home using the vehicle allocated to the predetermined facility.

According to the present disclosure, when the predetermined action is detected, it is possible to grasp a timing when the employee leaves the predetermined facility to return home (hereinafter may be referred to as an “exit timing”). Here, it is also considered that the exit timing is determined based on the schedule information of the employee. However, the employee does not always leave the predetermined facility to return home at a scheduled timing. On the other hand, when the predetermined action that is actually taken by the employee is detected, it is possible to grasp the actual exit timing of the employee. Therefore, it is possible to allocate the vehicle to the predetermined facility according to the actual exit timing of the employee. As a result, it is possible to improve convenience for the employee when the employee returns home from the predetermined facility.

Hereinafter, embodiments of the present disclosure will be described below with reference to the drawings. Unless otherwise specified, dimensions, materials, shapes, relative arrangements, and the like of components described in the embodiments are not intended to limit the technical scope of the present disclosure to those alone.

### First Embodiment

System Overview

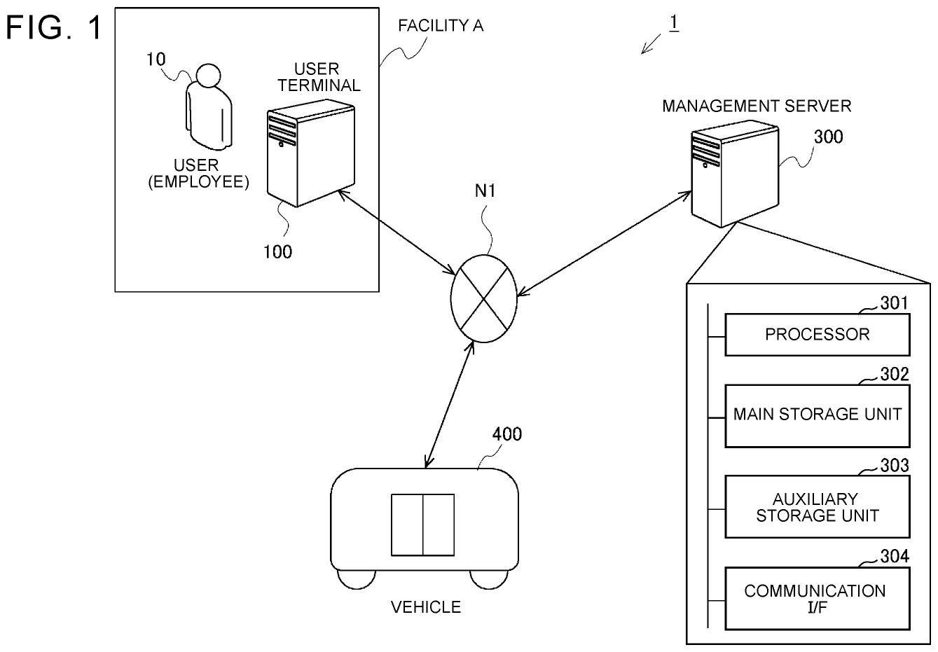

FIG. 1 is a diagram showing a schematic configuration of a vehicle allocation system. The vehicle allocation system 1 is a system for allocating a vehicle 400 to a predetermined facility A. The vehicle 400 allocated to the facility A is used when a user 10 who is an employee at the facility A returns home from the facility A. A type of the facility A is not particularly limited. The facility A may be, for example, a company, a factory, a hospital, or a store.

The vehicle allocation system 1 includes a user terminal 100, a management server 300, and the vehicle 400. In the vehicle allocation system 1, the user terminal 100, the management server 300, and the vehicle 400 are connected to each other by a network N1. As the network N1, for example, a wide area network (WAN) that is a world-wide public communication network such as the Internet, or a communication network for a telephone such as a cellar phone may be adopted.

As described above, the user 10 is the employee who works at the facility A. The user terminal 100 is a terminal that is provided in the facility A and associated with the user 10. That is, the user terminal 100 is a terminal used by the user 10 for working at the facility A. The user terminal 100 may be, for example, a personal computer or a tablet terminal.

The management server 300 is a server device for managing operation of the vehicle 400. The management server 300 includes a general computer. A computer constituting the management server 300 includes a processor 301, a main storage unit 302, an auxiliary storage unit 303, and a communication interface (communication I/F) 304.

The processor 301 is, for example, a central processing unit (CPU) or a digital signal processor (DSP). The main storage unit 302 is, for example, a random access memory (RAM). The auxiliary storage unit 303 is, for example, a read only memory (ROM), a hard disk drive (HDD), or a flash memory. Further, the auxiliary storage unit 303 may include a removable medium (portable recording medium). Here, the removable medium is, for example, a universal serial bus (USB) memory, a secure digital (SD) card, or a disc recording medium such as a compact disc read only memory (CD-ROM), a digital versatile disc (DVD), or a Blu-ray disc. The communication I/F 304 is, for example, a local area network (LAN) interface board or a wireless communication circuit for wireless communication.

The auxiliary storage unit 303 stores an operating system (OS), various programs, various information tables, and the like. Then, the processor 301 loads a program stored in the auxiliary storage unit 303 into the main storage unit 302 and executes the program, so that control for allocating the vehicle 400 as described later is realized. However, some or all of the functions in the management server 300 may be implemented by a hardware circuit such as an application specific integrated circuit (ASIC) or a field programmable gate array (FPGA). In the embodiment, the management server 300 corresponds to an “information processing device” according to the present disclosure.

When the user 10 finishes working and tries to return home from the facility A, the user 10 finishes using the user terminal 100. That is, the user 10 turns off the power of the user terminal 100 before leaving the facility A. Therefore, an action of turning off the power of the user terminal 100 (that is, shutting down the user terminal 100) can be regarded as a predetermined action taken by the user 10 to return home from the facility A.

Further, in the vehicle allocation system 1, the state of the user terminal 100 is monitored by the management server 300 via the network N1. Therefore, when the power of the user terminal 100 is turned off, the state of the user terminal 100 is detected by the management server 300. Then, when the management server 300 detects, as the predetermined action taken by the user 10 to return home from the facility A, an action of turning off the power of the user terminal 100, the management server 300 allocates the vehicle 400 to the facility A. Specifically, the management server 300 transmits, to the vehicle 400, an operation command for causing the vehicle 400 to travel toward the facility A via the network N1.

The vehicle 400 is an automatic driving vehicle capable of autonomous traveling. The vehicle 400 travels based on the operation command received from the management server 300. Therefore, when the vehicle 400 receives the operation command for causing the vehicle 400 to travel toward the facility A, the vehicle 400 travels toward the facility A. Then, when the vehicle 400 arrives at the facility A, the user 10 can ride in the vehicle 400 and return home from the facility A.

Functional Configuration

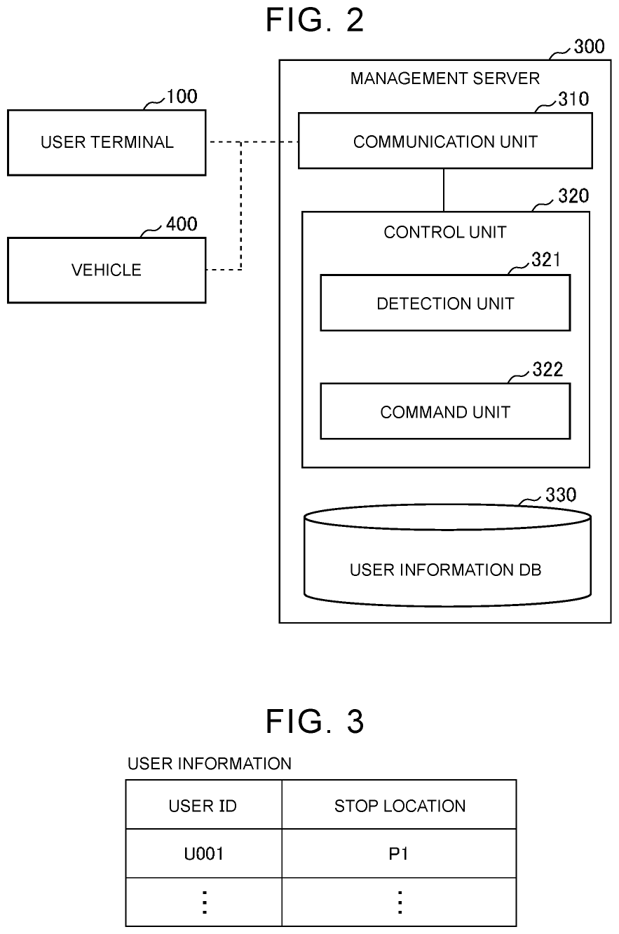

Next, a functional configuration of the management server 300 according to the embodiment will be described with reference to FIG. 2. FIG. 2 is a block diagram schematically showing an example of the functional configuration of the management server 300.

The management server 300 includes a communication unit 310, a control unit 320, and a user information database (user information DB) 330. The communication unit 310 has a function of connecting the management server 300 to the network N1. The communication unit 310 can be realized by the communication I/F 304. The control unit 320 has a function of performing arithmetic processing for controlling the management server 300. The control unit 320 can be realized by the processor 301. The control unit 320 performs a process of receiving a signal indicating the state of the user terminal 100 by using the communication unit 310. The signal is transmitted from the user terminal 100.

Further, the control unit 320 includes a detection unit 321 and a command unit 322 as functional units. The detection unit 321 has a function of detecting that the power of the user terminal 100 has been turned off based on the signal received from the user terminal 100.

The command unit 322 has a function of generating the operation command for the vehicle 400 and transmitting the generated operation command to the vehicle 400. When the detection unit 321 detects that the power of the user terminal 100 has been turned off, the command unit 322 generates the operation command for causing the vehicle 400 to travel toward the facility A. Then, the command unit 322 transmits the operation command to the vehicle 400 using the communication unit 310.

Further, at the facility A, a plurality of stop locations where the vehicle 400 can stop is determined in advance. Then, when the user 10 tries to use the vehicle 400 allocated to the facility A, the user 10 needs to ride in the vehicle 400 at any of the stop locations. Therefore, the user information DB 330 stores user information including information on the stop locations where the user 10 rides in the vehicle 400 at the facility A. The user information DB 330 also stores user information on each employee at the facility A other than the user 10. The user information DB 330 can be realized by the auxiliary storage unit 303 in the management server 300.

FIG. 3 is a diagram showing an example of a table configuration of the user information stored in the user information DB 330 according to the embodiment. As shown in FIG. 3, the user information includes a user identification (ID) field and a stop location field. In the user ID field, a user ID that is identification information for identifying a user (that is, an employee at the facility A) is stored. In the stop location field, information on the stop location associated with each user is stored. That is, a stop location where each user rides in the vehicle 400 in the facility A is set in advance. Then, information on the stop location set in advance is stored in the user information DB 330 with the information associated with the user ID.

The command unit 322 acquires the stop location associated with the user 10 from the user information DB 330. Further, the command unit 322 generates the operation command for causing the vehicle 400 to travel toward the facility A, and sets the destination of the vehicle 400 to the stop location associated with the user 10. Therefore, when the vehicle 400 receives the operation command transmitted by the command unit 322, the vehicle 400 travels toward the stop location associated with the user 10 as the destination. That is, the vehicle 400 is allocated to the stop location associated with the user 10 at the facility A.

In FIG. 2, the control unit 320 in the single management server 300 includes the detection unit 321 and the command unit 322. However, the management server 300 may not be necessarily realized by a single physical configuration, and may be configured by a plurality of computers that cooperates with each other. Therefore, the server device including the function of the detection unit 321 and the server device including the function of the command unit 322 may be separate devices.

Flow of Information Processing

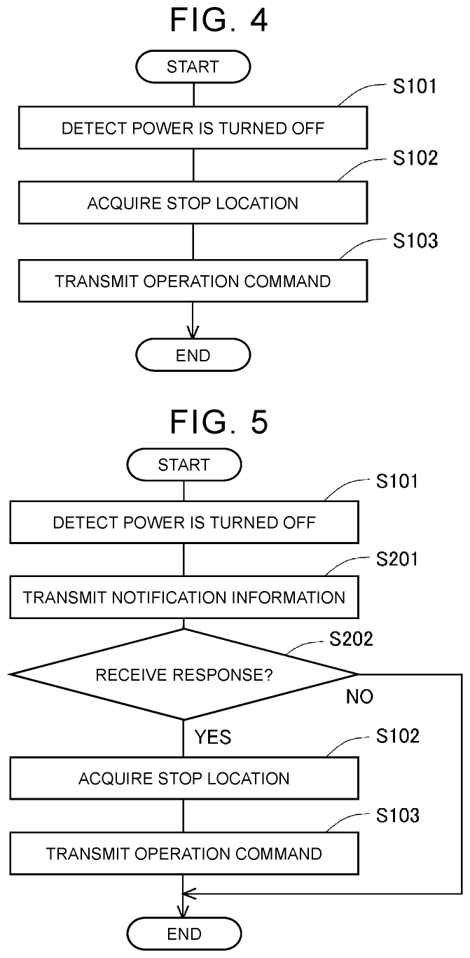

Next, flow of information processing performed on the management server 300 according to the embodiment will be described with reference to FIG. 4. FIG. 4 is a flowchart showing information processing performed on the management server 300. This flow is executed by the control unit 320.

In this flow, first, in S101, an action of turning off the power of the user terminal 100 is detected. Here, when the action of turning off the power of the user terminal 100 is detected, the user ID of the user 10 associated with the user terminal 100 is acquired. Next, in S102, information on the stop location associated with the user 10 is acquired from the user information DB 330 based on the user ID. Next, in S103, the operation command for causing the vehicle 400 to travel toward the facility A is generated and transmitted to the vehicle 400. In the operation command generated in S103, the stop location acquired in S102 is set as the destination of the vehicle 400.

With the vehicle allocation system 1 according to the embodiment, the vehicle 400 is allocated to the facility A at a timing when it is detected that the user 10 has turned off the power of the user terminal 100 to leave the facility A for returning home. Therefore, the vehicle 400 can be allocated to the facility A according to the actual exit timing of the user 10. Therefore, it is possible to improve convenience for the user 10 when the user 10 returns home from the facility A using the vehicle 400.

When a location where the allocated vehicle 400 is to stop is set in advance at the facility A, information on the stop location associated with the user 10 is not necessarily acquired in the information processing performed on the management server 300.

Modification

Here, the predetermined action taken by the user 10 to return home from the facility A is not limited to the action of turning off the power of the user terminal 100. Therefore, in the management server 300, the detection unit 321 of the control unit 320 may detect, as the predetermined action taken by the user 10 to return home from the facility A, an action other than the action of turning off the power of the user terminal 100.

For example, at the facility A, the user 10 may use predetermined equipment for work. Examples of the predetermined equipment include machine tools, experimental equipment, or production equipment. In this case, when the user 10 finishes working and tries to return home, the user 10 finishes using the predetermined equipment. That is, the user 10 turns off the power of the predetermined equipment before leaving the facility A. Therefore, an action of turning off the power of the predetermined equipment can be regarded as a predetermined action taken by the user 10 to return home from the facility A. Therefore, the detection unit 321 of the control unit 320 may detect the action of turning off the power of the predetermined equipment as the predetermined action taken by the user 10 to return home from the facility A.

In addition, the user 10 may pass through a predetermined gate when leaving the facility A for returning home. In this case, an action of passing through the predetermined gate can be regarded as the predetermined action taken by the user 10 to return home from the facility A. Further, when a sensor is provided at the predetermined gate, the sensor can detect that the user 10 has passed through the predetermined gate. Therefore, the detection unit 321 of the control unit 320 may detect the action of passing through the predetermined gate as the predetermined action taken by the user 10 to return home from the facility A.

### Second Embodiment

A schematic configuration of a vehicle allocation system according to an embodiment is the same as that of the first embodiment. However, in the embodiment, the user 10 possesses a mobile terminal different from the user terminal 100. Examples of the mobile terminal possessed by the user 10 include a smartphone or a wearable terminal.

In the embodiment, when the action of turning off the power of the user terminal 100 is detected in the management server 300, notification information is transmitted from the management server 300 to the mobile terminal possessed by the user 10 via the network N1. Here, the notification information is information for confirming whether the user 10 wishes allocation of the vehicle 400.

Flow of Information Processing

Next, flow of information processing performed on the management server 300 will be described with reference to FIG. 5. FIG. 5 is a flowchart showing information processing performed on the management server 300 according to the embodiment. This flow is executed by the control unit 320. The process executed in each step of S101 to S103 in the flow shown in FIG. 5 is the same as the process executed in each step having the same reference sign as that of FIG. 4 in the flow shown in FIG. 4. Therefore, the description of the processes in these steps is omitted.

In this flow, the process of S201 is executed following S101. In S201, the notification information is transmitted to the mobile terminal possessed by the user 10. The mobile terminal to which the notification information is transmitted may be registered in the management server 300 in advance with the mobile terminal associated with the user ID of the user 10. Then, when the mobile terminal receives the notification information transmitted from the management server 300, information for confirming whether the user 10 wishes the allocation of the vehicle 400 is notified to the user 10.

When the user 10 wishes the allocation of the vehicle 400, the user 10 inputs response information to the mobile terminal. As a result, the response information indicating that the user 10 wishes the allocation of the vehicle 400 is transmitted from the mobile terminal to the management server 300 via the network N1. On the other hand, the user 10 may not use the vehicle 400 when returning home from the facility A. In this case, the user 10 does not wish the allocation of the vehicle 400. Therefore, the response information indicating that the user 10 wishes the allocation of the vehicle 400 is not transmitted from the mobile terminal to the management server 300.

When the notification information is transmitted in S201, the management server 300 then executes the process of S202. In S202, it is determined whether the response information indicating that the user 10 wishes the allocation of the vehicle 400 is received from the mobile terminal of the user 10. When the determination result is Yes in S202, it is determined that the vehicle 400 is allocated to the facility A. Then, the process of S102 is executed next. On the other hand, when the determination result is No in S202, that is, when the response information indicating that the user 10 wishes the allocation of the vehicle 400 is not received, the processes of S102 and S103 are not executed and the information processing related to this flow is terminated. In this case, the vehicle 400 is not allocated to the facility A.

With the vehicle allocation system 1 according to the embodiment, the vehicle 400 is allocated to the facility A only when the user 10 leaving the facility A to return home needs the vehicle 400. In other words, it is possible to suppress the possibility that the vehicle 400 is allocated to the facility A although the user 10 does not need the vehicle 400.

### Third Embodiment

The schematic configuration of the vehicle allocation system according to an embodiment is the same as that of the first embodiment. In the embodiment, when the management server 300 detects that the power of the user terminal 100 has been turned off, schedule information of the user 10 is acquired. Then, it is determined whether to allocate the vehicle 400 to the facility A based on the schedule information.

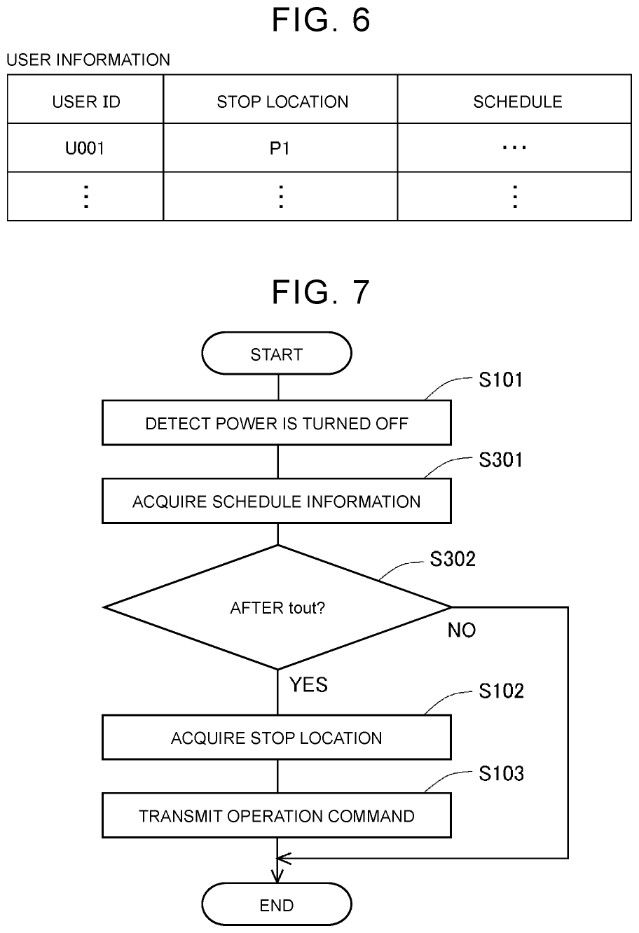

FIG. 6 is a diagram showing an example of a table configuration of the user information stored in the user information DB 330 according to the embodiment. As shown in FIG. 6, in the embodiment, the user information includes a schedule field in addition to the user ID field and the stop location field. In the schedule field, schedule information regarding the work for each user at the facility A is stored. The schedule information includes scheduled work end time for each user. Then, when the management server 300 detects that the power of the user terminal 100 has been turned off, the control unit 320 acquires the schedule information of the user 10 from the user information DB 330.

Flow of Information Processing

Next, flow of information processing performed on the management server 300 according to the embodiment will be described with reference to FIG. 7. FIG. 7 is a flowchart showing information processing performed on the management server 300. This flow is executed by the control unit 320. The process executed in each step of S101 to S103 in the flow shown in FIG. 7 is the same as the process executed in each step having the same reference sign as that of FIG. 5 in the flow shown in FIG. 5. Therefore, the description of the processes in these steps is omitted.

In this flow, the process of S301 is executed following S101. In S301, the schedule information of the user 10 is acquired from the user information DB 330 based on the user ID. Next, in S302, it is determined whether the time when turning off the power of the user terminal 100 (that is, the time when the user terminal 100 is shut down) is detected is after the scheduled work end time for the user 10 (tout), which is included in the schedule information.

Here, the user 10 may turn off the power of the user terminal 100 even when the user 10 is still working at the facility A. When the time when turning off the power of the user terminal 100 is detected is before the scheduled work end time for the user 10 (tout), the possibility that the user 10 still continues to work at the facility A is high. That is, the possibility that the user 10 leaves facility A to return home is low. On the other hand, when the time when turning off the power of the user terminal 100 is detected is after the scheduled work end time for the user 10 (tout), the possibility that the user 10 leaves the facility A to return home is extremely high.

When the determination result is Yes in s302, it is determined that the vehicle 400 is allocated to the facility A. Then, the process of S102 is executed next. On the other hand, when the determination result is No in S302, the information processing related to this flow is terminated without executing the processes of S102 and S103. In this case, the vehicle 400 is not allocated to the facility A.

With the vehicle allocation system 1 according to the embodiment, the vehicle 400 is allocated to the facility A when the possibility that the user 10 leaves the facility A to return home is higher. In other words, it is possible to suppress the possibility that the vehicle 400 is allocated to the facility A although the possibility that the user 10 leaves the facility A to return home is low.

Modifications

Transmission of the notification information to the mobile terminal possessed by the user 10 in the second embodiment described above may be incorporated into the flow of the information processing according to the embodiment. That is, when the time when turning off the power of the user terminal 100 is detected is before the scheduled work end time for the user 10 (tout) (that is, when the determination result is No in S302), the notification information may be transmitted from the management server 300 to the mobile terminal possessed by the user 10. Then, when the response information indicating that the user 10 wishes the allocation of the vehicle 400 is received from the mobile terminal of the user 10, it may be determined to allocate the vehicle 400 to the facility A.

Further, in the information processing according to the embodiment, the schedule information of the user 10 may not be necessarily acquired. For example, the scheduled work end time at the facility A may be set in advance. In this case, it may be determined whether the time when turning off the power of the user terminal 100 is detected is after the scheduled work end time at the facility A. Then, when the time when turning off the power of the user terminal 100 is detected is after the scheduled work end time at the facility A, it may be determined to allocate the vehicle 400 to the facility A. With the information processing described above as well, the vehicle 400 can be allocated to the facility A when the possibility that the user 10 leaves the facility A to return home is higher.

### Fourth Embodiment

In the embodiment, the management server 300 manages operation of a plurality of vehicles. Further, the vehicles whose operation is managed by the management server 300 include a plurality of types of vehicles having different capacities.

Functional Configuration

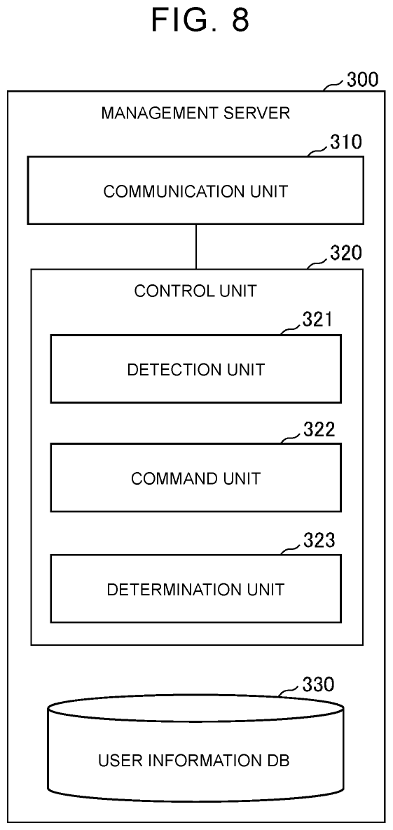

Next, a functional configuration of the management server 300 according to the embodiment will be described with reference to FIG. 8. FIG. 8 is a block diagram schematically showing an example of the functional configuration of the management server 300. In the embodiment, as in the first embodiment, the management server 300 includes the communication unit 310, the control unit 320, and the user information DB 330. The control unit 320 includes a determination unit 323 as a functional unit in addition to the detection unit 321 and the command unit 322. The determination unit 323 has a function of determining a vehicle 400 to be allocated to the facility A from among a plurality of vehicles.

A plurality of users may try to leave the facility A to return home at substantially the same time. In this case, the users turn off the powers of their respective user terminals at substantially the same time. Then, in the management server 300, the detection unit 321 detects that the powers of the user terminals are turned off at substantially the same time.

At this time, the number of user terminals whose powers are detected to be turned off by the detection unit 321 corresponds to the number of users who have turned off the powers of the user terminals to return home. Then, the determination unit 323 determines the vehicle 400 to be allocated to the facility A from among the vehicles based on the number of user terminals whose powers are detected to be turned off.

According to the embodiment, it is possible to allocate, to the facility A, the vehicle 400 corresponding to the number of users who leaves the the facility A to return home. For example, when one user leaves the facility A, a single-seat vehicle can be allocated to the facility A. Further, when a plurality of users leaves the facility A, a vehicle whose capacity is suitable for the number of users can be allocated to the facility A.

Modification

When the detection unit 321 detects that the powers of a plurality of user terminals have been turned off at substantially the same time in the management server 300, that is, when a plurality of users leaves the facility A, the control unit 320 may acquire information on an area where home of each user is located. The information on the area where the home of each user is located may be stored in the user information DB 330 in advance. Then, the control unit 320 may allocate one vehicle as a vehicle for the users whose homes are located in the same area such that the users ride together. Further, at this time, a vehicle corresponding to the number of users whose homes are located in the same area may be allocated.

With the vehicle allocation system 1 according to each of the above embodiments, the vehicle 400 is an automatic driving vehicle. However, the vehicle allocated to the facility A may not be necessarily the automatic driving vehicle. That is, the vehicle allocated to the facility A may be a vehicle driven by a driver. In this case, a command for allocating the vehicle toward the facility A is transmitted from the management server 300 to a terminal related to the driver (for example, a terminal possessed by the driver).

### Other Embodiments

The above-described embodiments are merely examples, and the present disclosure may be appropriately modified and implemented without departing from the scope thereof. For example, the processes and means described in the present disclosure can be freely combined and implemented as long as no technical contradiction occurs.

Further, the processes described as being executed by one device may be shared and executed by a plurality of devices. Alternatively, the processes described as being executed by different devices may be executed by one device. In the computer system, it is possible to flexibly change the hardware configuration (server configuration) for realizing each function.

The present disclosure can also be implemented by supplying a computer with a computer program that implements the functions described in the above embodiments, and causing one or more processors of the computer to read and execute the program. Such a computer program may be provided to the computer by a non-transitory computer-readable storage medium connectable to the system bus of the computer, or may be provided to the computer via a network. The non-transitory computer-readable storage medium is, for example, a disc of any type such as a magnetic disc (floppy (registered trademark) disc, hard disk drive (HDD), etc.), an optical disc (compact disc read-only memory (CD-ROM), digital versatile disc (DVD), Blu-ray disc, etc.), a read only memory (ROM), a random access memory (RAM), an erasable programmable read only memory (EPROM), an electrically erasable programmable read only memory (EEPROM), a magnetic card, a flash memory, or any type of medium suitable for storing electronic commands such as an optical card.

What is claimed is:

1. An information processing device comprising a control unit, wherein the control unit executes:
detecting a predetermined action taken by an employee to return home from a predetermined facility; and
allocating, to the predetermined facility, a vehicle in which the employee rides, when the predetermined action is detected.

2. The information processing device according to claim 1, wherein the predetermined action is an action in which the employee finishes using a predetermined apparatus associated with the employee at the predetermined facility.

3. The information processing device according to claim 2, wherein:
the predetermined apparatus is a predetermined terminal or predetermined equipment, the predetermined terminal or the predetermined equipment being used by the employee for work; and
the predetermined action is an action of turning off a power of the predetermined terminal or the predetermined equipment.

4. The information processing device according to claim 1, wherein the predetermined action is an action in which the employee passes through a predetermined gate when leaving the predetermined facility to return home.

5. The information processing device according to claim 1, wherein the control unit further executes:
acquiring schedule information of the employee when the predetermined action is detected; and
determining whether to allocate the vehicle to the predetermined facility based on the schedule information.

6. The information processing device according to claim 5, wherein when time at which the predetermined action is detected is after scheduled work end time for the employee, the scheduled work end time being included in the schedule information, the control unit determines to allocate the vehicle to the predetermined facility.

7. The information processing device according to claim 1, wherein when time at which the predetermined action is detected is after scheduled work end time set in advance at the predetermined facility, the control unit further executes determining to allocate the vehicle to the predetermined facility.

8. The information processing device according to claim 1, wherein the control unit further executes:
notifying the employee of information for confirming whether the employee wishes allocation of the vehicle when the predetermined action is detected; and
determining to allocate the vehicle to the predetermined facility when the control unit receives a response that the employee wishes the allocation of the vehicle.

9. The information processing device according to claim 1, wherein:
a plurality of stop locations where the vehicle is able to stop is set in advance at the predetermined facility; and
when the control unit allocates the vehicle to the predetermined facility, the control unit allocates the vehicle to a stop location associated with the employee among the stop locations.

10. The information processing device according to claim 1, wherein the control unit further executes determining the vehicle to be allocated to the predetermined facility based on the number of employees whose predetermined actions are detected.

11. An information processing method executed by a computer, the information processing method comprising:
detecting a predetermined action taken by an employee to return home from a predetermined facility; and
allocating, to the predetermined facility, a vehicle in which the employee rides, when the predetermined action is detected.

12. The information processing method according to claim 11, wherein the predetermined action is an action in which the employee finishes using a predetermined apparatus associated with the employee at the predetermined facility.

13. The information processing method according to claim 12, wherein
the predetermined apparatus is a predetermined terminal or predetermined equipment, the predetermined terminal or the predetermined equipment being used by the employee for work; and
the predetermined action is an action of turning off a power of the predetermined terminal or the predetermined equipment.

14. The information processing method according to claim 11, wherein the predetermined action is an action in which the employee passes through a predetermined gate when leaving the predetermined facility to return home.

15. The information processing method according to claim 11, the information processing method further comprising:
acquiring schedule information of the employee when the predetermined action is detected; and
determining whether to allocate the vehicle to the predetermined facility based on the schedule information.

16. The information processing method according to claim 15, wherein when time at which the predetermined action is detected is after scheduled work end time for the employee, the scheduled work end time being included in the schedule information, a control unit determines to allocate the vehicle to the predetermined facility.

17. The information processing method according to claim 11, wherein when time at which the predetermined action is detected is after scheduled work end time set in advance at the predetermined facility, a control unit determines to allocate the vehicle to the predetermined facility.

18. The information processing method according to claim 11, the information processing method further comprising:
notifying the employee of information for confirming whether the employee wishes allocation of the vehicle when the predetermined action is detected; and
determining to allocate the vehicle to the predetermined facility when the control unit receives a response that the employee wishes the allocation of the vehicle.

19. The information processing method according to claim 11, wherein:
a plurality of stop locations where the vehicle is able to stop is set in advance at the predetermined facility; and
when the control unit allocates the vehicle to the predetermined facility, the control unit allocates the vehicle to a stop location associated with the employee among the stop locations.

20. A program that causes a computer to execute an information processing method, the information processing method comprising:
detecting a predetermined action taken by an employee to return home from a predetermined facility; and
allocating, to the predetermined facility, a vehicle in which the employee rides, when the predetermined action is detected.
